(19) United States
(12) Patent Application Publication
(10) Pub. No.: US 2024/0391629 A1
(43) Pub. Date: Nov. 28, 2024

(54) LABEL ALIGNER FOR CYLINDRICAL PRODUCTS INCLUDING BUT NOT LIMITED TO BOTTLES, JARS AND CUPS

(71) Applicant: Sheldon Barrett, Punta Gorda, FL (US)

(72) Inventor: Sheldon Barrett, Punta Gorda, FL (US)

(21) Appl. No.: 18/672,795

(22) Filed: May 23, 2024

Related U.S. Application Data
(60) Provisional application No. 63/468,762, filed on May 24, 2023.

(51) Int. Cl. B65C 9/00; B65C 3/08

(52) U.S. Cl. CPC B65C 9/0015; B65C 3/08

(57) ABSTRACT

An adjustable belt and loop system provides a use to consistently align and attach labels and at correct heights onto cylindrical products. This belt and loop are flexible with a narrow end attached to its opposite end using a loop from one or more cut slits. The diameter of the belt and loop are adjustable by the user using two tabs. This adjustable diameter formed by the belt and loop must be tightened and secured onto the outside of cylindrical products with varying diameters. This belt and loop contain a cut-out or groove and graphics to indicate where the user should align and attach their labels onto the cylindrical product to have their labels attach straight and at a correct height. Combination of belts and loops can define various geometries to position different types of labels and to different bottles or other cylindrical products.

### CROSS-REFERENCE TO RELATED APPLICATION

This application claims the benefit of priority pursuant to U.S.C. § 119 (e) of U.S. Provisional patent Application Ser. No. 63/468,762, entitled LABEL ALIGNER FOR CYLINDRICAL PRODUCTS INCLUDING BUT NOT LIMITED TO BOTTLES, JARS AND CUPS, filed May 24, 2023, which is hereby incorporated by reference in its entirety for all purposes.

### BACKGROUND OF THE INVENTION

### Field of the Invention

This label aligner is a belt and loop made from a flexible sheet and secured itself around the outside of cylindrical products, such as bottles, to provide the user a location to consistently apply their labels straight and at the correct height.

### Description of the Related Art

When manually applying a label to a cylindrical product including (but not limited to) bottles, jars, and cups, it is difficult to apply the label straight and at the correct height. Often the label will be applied crooked. It is more difficult to apply labels to multiple identical bottles and have their placement consistent with one another by not being crooked and at differing heights. This inconsistency in label placement will seem unprofessional when the user is trying to attain a certain look, such as labels on coffee bean containers in an upscale kitchen or shop.

Many labels are professionally attached in factories using machinery. But there are few solutions which professionally attach labels for the at-home users seeking to customize their cylindrical products.

Creating an aligner solution from machining, casting, injection molding, or similar manufacturing procedures is not only expensive, but can also be bulky. It would be difficult to economically ship such bulky designs to users or bundle them with cylindrical products needing to be labeled.

### BRIEF SUMMARY OF THE INVENTION

This label aligner is designed to allow the user to consistently apply their labels to their substantially cylindrical products every time. It is made from a flexible sheet and has a belt and loop design to secure itself around the outside of the cylindrical product. This label aligner is adjustable to fit around cylindrical products with varying diameters. The label aligner sits flush with the surface it shares with itself and the cylindrical product. There is a groove cut on the top edge of this label aligner accompanied with graphical designs to indicate where the user should place their label to consistently apply it to their cylindrical product straight and at the correct height.

This label aligner can be cut from flexible materials such as paper or plastic, which is a very inexpensive manufacturing procedure. Shipping of this label aligner will also be inexpensive since it is very lightweight. This invention may also be conveniently wrapped around cylindrical products needing labels and then shipped to users without any significant increase in shipping costs.

It is an object of the invention to provide consistent and corrected aligned and attached labels to heights of substantially cylindrical products.

It is another object to provide combinations of belts and loops to define various geometries to position different types of labels and with different bottles.

The above and yet other objects and advantages of the present invention will become apparent from the hereinafter set forth Brief Description of the Drawings, detailed Description of the Invention, and Claims appended herewith.

### BRIEF DESCRIPTION OF THE DRAWINGS

FIG. 1A. is a flat linear aspect of the label aligner of the system.

FIG. 1B. is a detailed aspect of FIG. 1A showing the steps of the system of the invention.

FIG. 1C. is a detailed aspect of FIGS. 1A and 1B showing use of multiple cut-lines for the right tab of the system

FIG. 2A. is a representative bottle used in the label of the system.

FIG. 2B. is a first step of the labeling system.

FIG. 2C. is a second step of the above invention.

FIG. 3. is a further step of the above.

FIG. 4. is a figure further step showing the tightening of the label aligner onto the bottle.

FIG. 5. is a further step showing the alignment of the label position onto the bottle, using the horizontal edge of the label aligner's upper groove.

FIG. 6. shows the label pressed to the top of the label alignment device.

FIG. 7. is a view of three similar completed labels and bottles.

FIG. 8. is a photograph of the label alignment system positioned to said label.

FIG. 9. is a photograph of the present label alignment system.

FIG. 10. provides nine different embodiments of the label alignment device, as set forth below in the Description of the Invention.

### DETAILED DESCRIPTION OF INVENTION

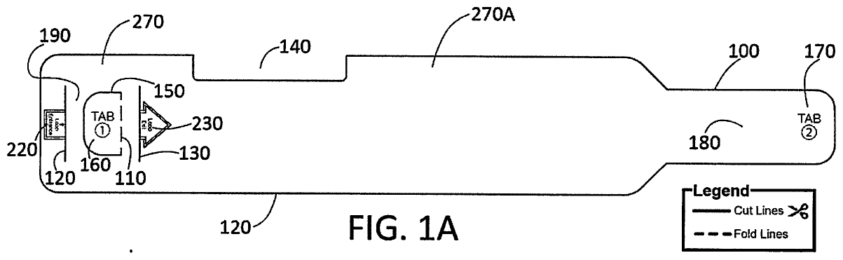

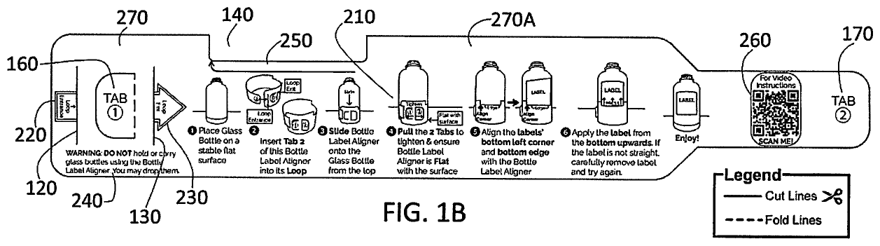

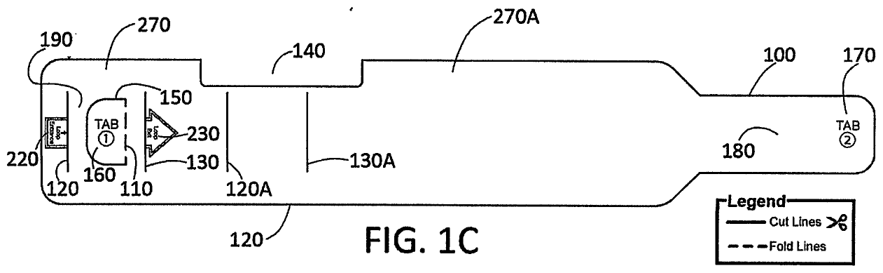

FIG. 1A is the front 2D view of the label aligner for cylindrical products. As an example, its dimensions are 317 mm by 55 mm (12.48 inches×2.17 inches). This label aligner for cylindrical products is made from a single flexible sheet, such as paper or plastic. The lines 100 are the cut lines which serve as the borders of this label aligner, forming its shape. There are also cut-lines shown at 120 the loop entrance slot, the loop exit slot 130, and the cut lines 150 needed to make TAB1, 160. There black dash lines are fold lines 110 which are used at to bend 160 TAB 1 slightly outwards allowing the user to more easily grip it. The loop 190 is the area between 120 the loop entrance slot, and the loop exit slot 130.

The narrow end of this label aligner 180 serves as the belt. The narrow end (belt) 180 is inserted into the loop 190 by first entering the loop entrance slot 120, then exiting the loop exit slot 130. After this insertion, TAB 1 160 and TAB 2 170 are gripped by the user and pulled opposite from one another to tighten this label aligner around a cylindrical product. The groove 140 on the top of the label aligner indicates to the user where they should place their labels so that it is not crooked and at the correct height. The width of this groove 140 is cut to be slightly larger than the width of the label intended for use. The bottom edge of groove 140 is horizontal and is where users will align the bottom of their labels to avoid applying it crooked. The left and right edges of groove 140 are vertical and also indicates where users should align their label to avoid applying it crooked. The bottom edge of the label aligner for cylindrical products 200 is horizontal. The bottom edge of groove 140 is parallel to the bottom edge of the label aligner for cylindrical products 200.

FIG. 1B is similar to FIG. 1A, with the addition of graphical designs used to assist the user. These graphic designs are provided to the manufacturer for printing directly on this label aligner for cylindrical products. Graphical design is used to indicate the location of TAB1 160. to the user, whereas graphical design is used to indicate the location of TAB2 170. Multi-step instructional graphics 210 is printed along the middle of this label aligner. The tail of the arrow graphical design 220 indicates to the user the location of the loop entrance slot of where they should first insert TAB2 170. The pointer of the arrow graphical design 230 indicates to the user the location of the loop exit slot of where they should next insert TAB2 170. Warning graphic 240 tells the user to not carry their cylindrical products using this label aligner, as they may drop it which can be dangerous. Graphic 250 is printed just below groove 140, to indicate to the user where to align their labels' corner and bottom edge to avoid it being applied crooked and at the wrong height. Graphic 260 is a QR code that links to video instructions when users use their smartphone camera to scan it. Graphic 270 and 270A indicates what this product is used for just in case the user does not recognize it at first.

In FIG. 1C is a detailed aspect of FIG. 1A and FIG. 1B showing the use of multiple cut-lines 120A (the belt re-entry slot) and 130A (also for belt re-exit slot) for the right tab.

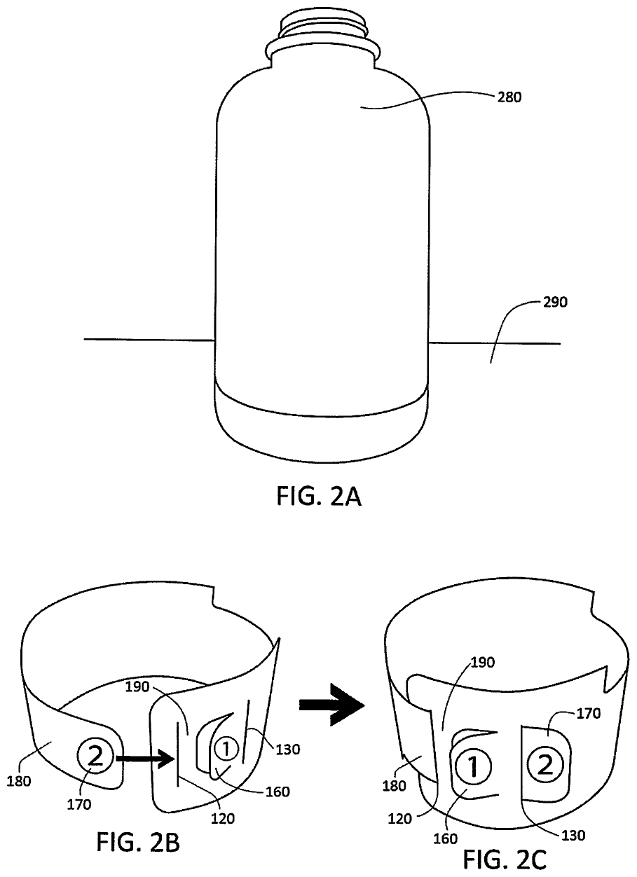

FIG. 2A is the front view of the first preliminary step which needs to be taken before the user can use the label aligner for cylindrical products. The cylindrical product 280 must be placed on a flat surface 290. In this example we are using a cylindrical glass bottle product.

FIG. 2B and FIG. 2C is the front perspective view of the label aligner for cylindrical products second step as TAB2 170 and narrow end (belt) 180 is inserted into the loop 190. First, TAB2 170 is inserted into loop entrance slot 120 from the front. Next, TAB2 170 is inserted into loop exit slot 130 from the back. Narrow end (belt) 180 should be inserted behind TAB1 160 and must not block it. To adjust this label aligner diameter, the user can tighten it by pulling TAB1 160 and TAB2 170 in the opposite direction of one another. Because of this adjustable feature, this label aligner for cylindrical products can be adjusted to fit around the outside of cylindrical products of varying diameters.

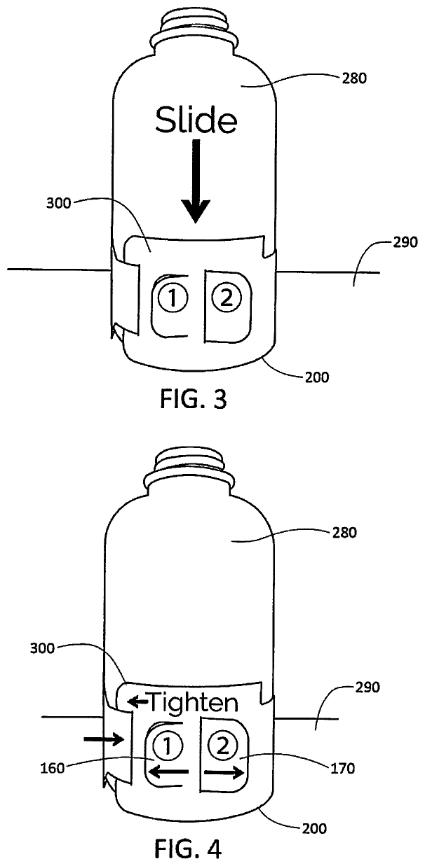

FIG. 3 is the front view of the third step where the entire label aligner for cylindrical products 300 is slid onto the cylindrical product 280 from the top. The label aligner 300 should slide all the way down to the bottom of the cylindrical product 280 and have its bottom edge 200 be flush and straight with flat surface 290.

FIG. 4 is the front view of the fourth step where the label aligner for cylindrical products 300 is tightened onto the outside of the cylindrical product 280. The user tightens this Label Aligner by pulling TAB1 160 and TAB2 170 in the opposite direction of one another. The user must now ensure that the label aligner 300 is still slid to the bottom of the cylindrical product 280, and still has its bottom edge 200 be flush and straight with flat surface 290.

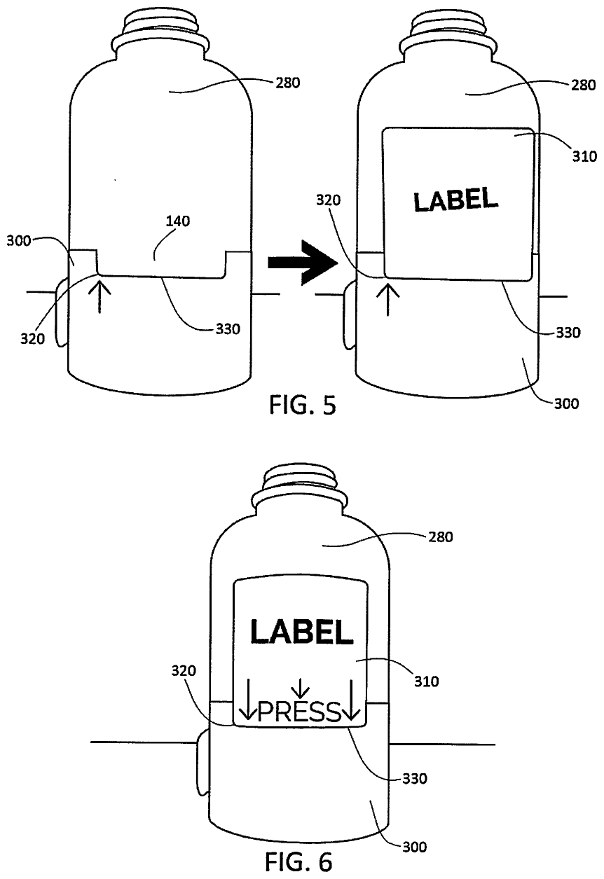

FIG. 5 is the front view of the fifth step where the label 310 is aligned with the groove 140 in the label aligner for cylindrical products 300. The bottom left corner of the label 310 should first be aligned with the bottom left corner of the groove 320. Next, the bottom edge of the label 310 should be aligned with the entire bottom edge of the groove 330. The right side of label 310 looks larger here in FIG. 5 because it is being held by the user and is further away from the cylindrical product 280 compared to the left side of label 310. In this step, the label should only be aligned and not yet attached to the cylindrical product 280.

FIG. 6 is the front view of the sixth step where the label 310 is applied to the cylindrical product 280. In this example, label 310 has an adhesive backing (which this label aligner is not limited to) to attach itself onto the cylindrical product 280. This label 310 should first be applied at its entire bottom edge 330. To avoid air bubbles behind label 310, it should next be applied from its bottom edge upwards. Label 310 should only be fully applied to the cylindrical product 280 if its bottom edge is confirmed to be aligned with the bottom edge of the label aligner groove 330. If the label 310 is not aligned properly and is crooked, the user may carefully remove the label 310 and try again. If the label 310 is aligned properly and fully applied to the cylindrical product 280, the user should finally slide cylindrical product 280 up and out of the label aligner for cylindrical products 300.

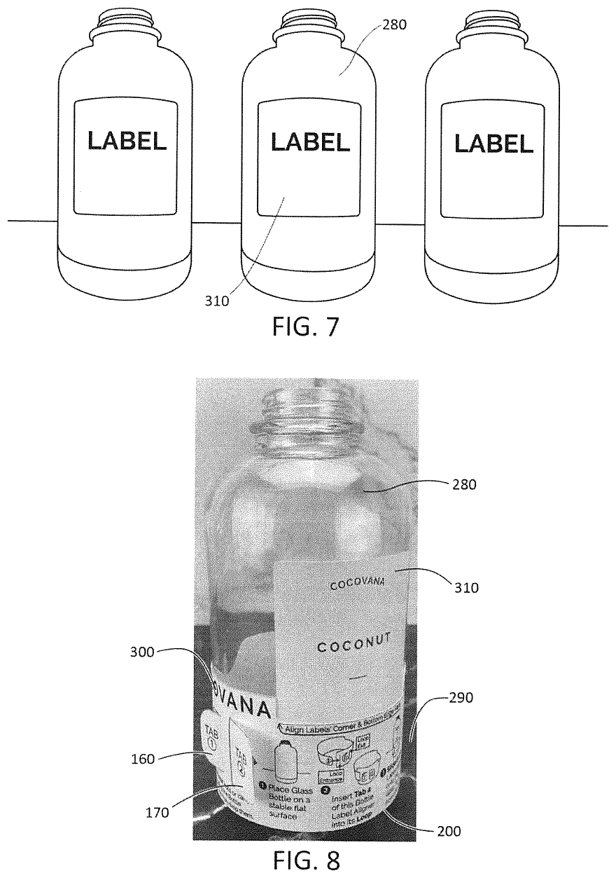

FIG. 7 is the front view of multiple cylindrical products 280 that used the label aligner for cylindrical products to apply their labels 310 consistently straight and at the correct height. Because each label 310 was placed at identical locations on each cylindrical product 280 by the user's own hands, together they achieve a professional look as if they were assembled by machines in a factory.

FIG. 8 is the front view photograph of the label aligner for cylindrical products attached around a cylindrical product, with a label applied straight and at the correct height. TABS 1 and 2 were pulled in opposite directions of one another to tighten this label aligner around the outside of this cylindrical product. The label aligner is sitting flush with the flat surface it shares with the cylindrical product. The label was properly aligned using the cutout groove and graphical indicator at the top of this label aligner.

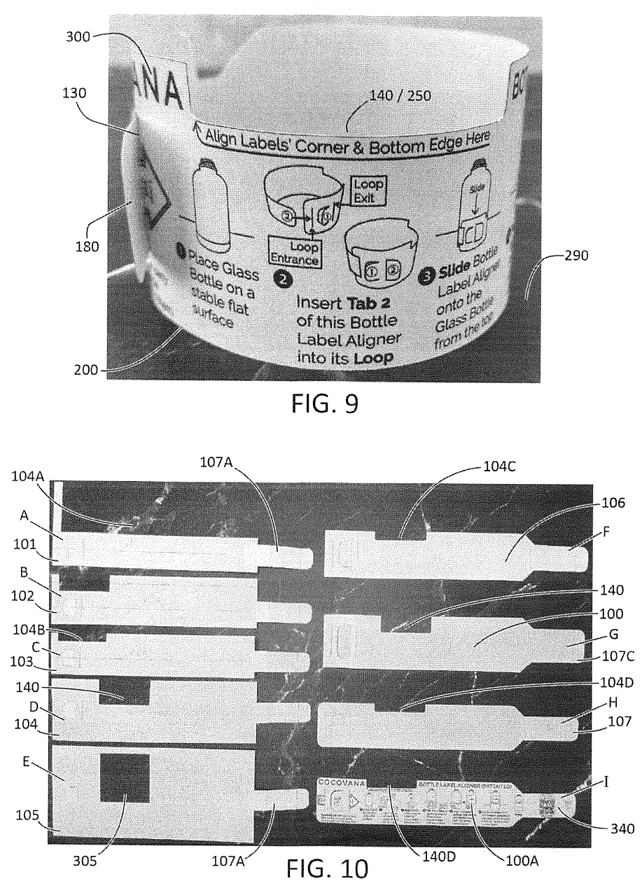

FIG. 9 is the front view photograph of the label aligner for cylindrical products alone sitting on a flat surface. The narrow end is inserted into the loops' entrance and exit slots allowing it to form an adjustable diameter. All edges of the groove used to indicate where to place the label is visible.

FIG. 10 is the top view photograph of the many iterative prototypes of the label aligner for cylindrical products. In FIG. 10A shows the first geometry 101, 104A and 107A of the said label. In FIG. 10B is showing a second embodiment 102 of the label. In FIG. 10C is showing the third embodiment 103 and 104B. In FIG. 10D is provided a fourth embodiment 104 and 140 of the label. In FIG. 10E is shown a fifth embodiment 105, 107A and 305. In FIG. 10F shows a six embodiment 104C and 106. In FIG. 10G is shown 100, 107C and 140 is a seventh embodiment. In FIG. 10H is shown 104D and 107 in an eighth embodiment. In FIG. 10I is shown 100A, 140D and 340 of the invention also shown in FIG. 1B. Therein various geometry of the labels may be used within the scope of the system and method herewith.

While there has been show and described above the preferred embodiment of the instant invention it is to be appreciated that the invention may be embodied otherwise than is herein specifically shown and described and then certain changes may be made in the form and arrangement of the parts without departing from the underlying ideas or principles of this invention as set forth in the Claims appended herewith.

1. A system for providing a label for a substantially cylindrical product such as a bottle, comprising:
a label aligner having a left tab and a right tab, the left tab having a loop entrance to the left of the tab and a loop exit at the right above of said left tab;
a groove within upper side of the label aligner proportioned for positioning onto the bottle said label attached substantially about a diameter of the cylindrical product;
insertion of the right tab and into the loop entrance and exit; and
slightly of the label onto the groove of the label aligner,
wherein said bottle is upon a flat surface.

2. The system has recited in claim 1, comprising:
said label aligner defining a sheet of flexible material.

3. The system as recited in claim 2, comprising:
the label aligner is not limited to a loop.

4. The system has recited claim 1, comprising:
an attachment of said right tab moved into one or more cut-lines of a different location of the system.

5. The system as recited in claim 4, comprising:
a position of the bottom of said label aligner and straightened along the lower height of the bottom of the bottle.

6. The system as recited in claim 5, comprising:
a groove of the edge of the label aligner defining a top and narrowed or belt of said label aligner.

7. The system as recited in claim 2, of said bottle, comprising:
a jar or a cup

8. The system as recited in claim 2, comprising:
said label having a bottom left corner and a bottom edge substantially against said bottle.

9. The system as recited in claim 2 comprising:
said label having a bottom right corner and a bottom edge substantially against said bottle.

10. A method for providing a label about a substantially cylindrical product such as a bottle, comprising:
using of a label aligner having a left tab and a right tab, the left tab having a loop entrance to the left of said left tab and a loop exit at the right above said left tab;
using a groove within upper side of the label aligner proportioned for positioning onto a label bottle of a cylindrical groove;
positioning a label to loop around a diameter of the cylindrical product;
inserting at the right tab and into the loop entrance and exit; and
sliding off of the label onto that groove of the label aligner, wherein said bottle is upon a flat surface.

11. The method has recited in claim 10, comprising:
said label aligner defining a sheet of flexible material.

12. The method as recited in claim 11, comprising:
the label aligner is not limited to a loop.

13. The method has recited claim 10, comprising:
an attachment of said right tab moved into one or more cut-lines of a different location of the method.

14. The method as recited in claim 13, comprising:
a positioning of the bottom of said label aligner and straightened along at a substantial height of the bottom of the bottle.

15. The method as recited in claim 14 comprising:
a groove of the edge of the label aligner at a top and narrowed or belt of said label aligner.

16. The method as recited in claim 11, of said bottle, comprising:
a jar or a cup.

17. The method as recited in claim 11, comprising:
said label having a bottom left corner and a bottom edge substantially against said bottle.

18. The method as recited in claim 11, comprising; said label
having a bottom right corner and bottom edge substantially against said bottle.
